(19) United States
(12) Patent Application Publication
(10) Pub. No.: US 2009/0253462 A1
(43) Pub. Date: Oct. 8, 2009

(54) SCALEABLE BASE STATION ARCHITECTURE

(76) Inventors: Christopher J. Capece, Lebanon, NJ (US); Gregg Nardozza, Madison, NJ (US)

Correspondence Address: CARLSON, GASKEY & OLDS, P.C./Alcatel-Lucent, 400 W MAPLE RD, SUITE 350, BIRMINGHAM, MI, 48009, US

(21) Appl. No.: 12/061,056

(22) Filed: Apr. 2, 2008

(51) Int. Cl. H04M 1/00

(52) U.S. Cl. 455/562.1

(57) ABSTRACT

An exemplary base station device includes a plurality of antennas configured to serve a plurality of sectors. A plurality of radios are coupled with the antennas for processing signals communicated on the antennas. One of the radios is coupled with at least one antenna that serves one of the sectors. The same radio is coupled with an antenna in a different one of the sectors. Another radio is coupled with a different one of the antennas in the one sector and at least one other antenna in a different sector. Such an arrangement of radios and antennas provides for at least simplex communication within each sector even if one of the radios fails.

### 1. TECHNICAL FIELD

This invention generally relates to communication. More particularly, this invention relates to wireless communication.

### 2. DESCRIPTION OF THE RELATED ART

Wireless communication systems are typically referred to as cellular communication systems. The term “cellular” comes from the way in which geographic regions are divided up into sections or cells. A base station (BTS) is arranged to provide wireless communication coverage within a cell. There are a variety of known factors that impact how base stations are arranged to provide a desired amount of wireless communication coverage within a particular geographic area.

Typical base stations are utilized to provide wireless coverage within an entire cell. Each cell is usually divided into a plurality of sectors. A common arrangement involves three sectors within each cell. Each base station has at least one antenna for serving each sector and a radio dedicated to processing communications within each sector. For example, a three-sector base station will have three radios, each one being dedicated to a particular sector.

Such conventional arrangements have proven useful. One drawback associated with them is that when one of the radios fails to operate, coverage within an entire sector of the cell may be lost. This may occur if an entire radio fails or if particular components of a radio fail that impact the ability of that radio to provide wireless communication services within the corresponding sector.

One proposed arrangement to address a situation involving a failed radio is to have a backup radio to provide coverage in the event that one of the radios of a base station fails. One drawback associated with this proposed solution is that it introduces additional components and expense. For example, an entire radio must be sitting unused waiting to provide backup coverage if needed. In addition to the extra expenses associated with providing duplicate radios for backup purposes, there are technical challenges associated with switching in a backup radio as circumstances require.

### SUMMARY

An exemplary base station device includes a plurality of antennas configured to serve a plurality of sectors. A plurality of radios are coupled with the antennas for processing signals communicated on the antennas. One of the radios is coupled with at least one antenna that serves one of the sectors. The same radio is coupled with an antenna in a different one of the sectors. Another radio is coupled with a different one of the antennas in the one sector and at least one other antenna in a different sector. Such an arrangement of radios and antennas provides for at least simplex communication within each sector even if one of the radios fails.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates an exemplary base station arrangement designed according to an embodiment of this invention.

FIG. 2 schematically illustrates selected portions of an exemplary base station arrangement in a first operating condition.

FIG. 3 schematically illustrates the arrangement of FIG. 2 in a second operating condition.

FIG. 4 schematically illustrates the arrangement of FIG. 2 in another operating condition.

### DETAILED DESCRIPTION

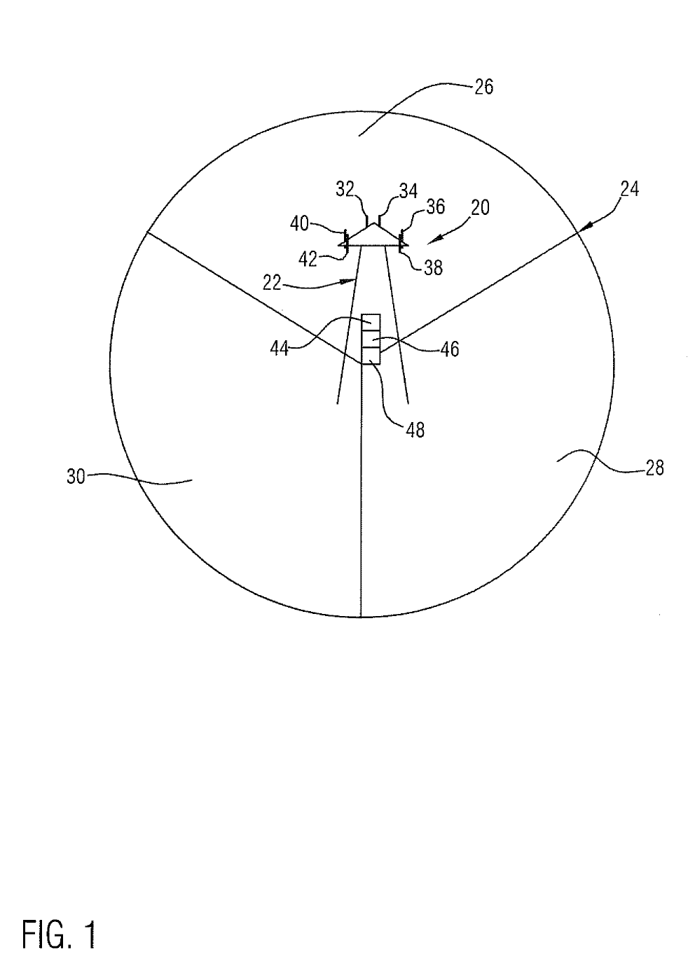

FIG. 1 schematically shows a base station device 20. This example includes a base station tower 22 situated in a selected geographic region to provide wireless communication coverage within a cell 24. In this example, the cell 24 is divided into a plurality of sectors. The example of FIG. 1 includes a first section 26, a second sector 28 and a third section 30.

The example base station device 20 includes a plurality of antennas supported on the tower 22 to provide wireless communication service coverage within each of the sectors. In this example, a plurality of first sector antennas 32 and 34 are configured to provide wireless communications coverage for serving the first sector 26. A plurality of second sector antennas 36 and 38 serve the second sector 28. Third sector antennas 40 and 42 serve the third sector 30.

Having a plurality of antennas configured to serve each of the sectors provides for duplex communications (e.g., transmissions and receptions) in each of the sectors. There are known diversity communication techniques for using a plurality of antennas. An example embodiment designed according to the arrangement of FIG. 1 uses such known diversity communication techniques.

The example of FIG. 1 includes a plurality of radios associated with the antennas for processing wireless communication signals to provide wireless communication services within the cell 24. This example includes a first radio 44, a second radio 46 and a third radio 48. The plurality of radios 44-48 are coupled with the antennas 32-42 in a unique manner that provides for diversity communications within the sectors 26, 28 and 30 when all of the radios are properly functioning. If one of the radios should fail or if an important component of a radio becomes inoperative, the unique arrangement provides for at least simplex communications within each of the sectors and still supports duplex communications in at least one of the sectors under most circumstances. The disclosed example arrangement avoids losing coverage within an entire sector even though an entire radio of a base station fails.

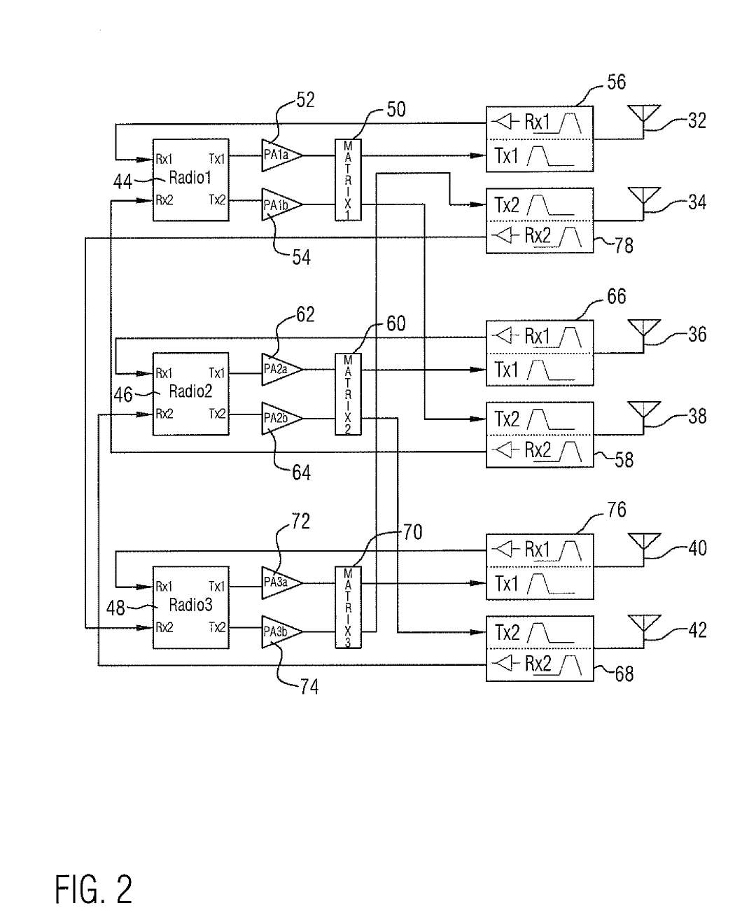

FIG. 2 schematically illustrates one example arrangement for coupling the radios 44-48 to the antennas 32-42. In this example, the first radio 44 is coupled to one of the first sector antennas 32. The first radio 44 uses known techniques for processing communication signals transmitted from or received by the first sector antenna 32. The first radio 44 is also coupled to one of the second sector antennas. In this example, the first radio 44 is coupled to the second sector antenna 38. The first radio 44 uses known communication techniques for processing communication signals transmitted from or received at the second sector antenna 38.

The first radio 44 has a butler matrix associated with it for processing the communication signals associated with the antennas 32 and 38. In this example, a matrix portion 50 divides digitally mixed signals output by amplifiers 52 and 54. Utilizing a butler matrix allows for pooling the amplifier power of the amplifiers 52 and 54 and dividing that power unevenly if desired among the antennas 32 and 38, which are in the first sector 26 and the second section 38, respectively in this example.

The first sector antenna 32 has an associated filter 56 and the second sector antenna 38 has an associated filter 58. The filters 56 and 58 operate in a known manner for handling signals at the antennas.

The second radio 46 is coupled with the other example second sector antenna 36. The second radio 46 is also coupled with one of the third sector antennas. In this example, the second radio 46 is coupled with the third sector antenna 42.

The second radio 46 has an associated butler matrix arrangement including a matrix portion 60 and amplifiers 62 and 64. The antenna 36 has an associated filter 66 and the antenna 42 has an associated filter 68. The second radio 46 processes signals communicated at the second sector antenna 36 and the third sector antenna 42.

The third radio 48 in this example is coupled with the other third section antenna in the illustrated arrangement. In this example, the third radio 48 is coupled with the third sector antenna 40. The third radio 48 is also coupled with the other first sector antenna, which in this example is the first sector antenna 34.

The third radio 48 also has a known butler matrix arrangement associated with it including a matrix portion 70 and amplifier 72 and 74. The third sector antenna 40 has an associated filter 76 that operates in a known manner and the first sector antenna 34 has an associated filter 78 that operates in a known manner.

As can be appreciated from FIG. 2, each of the antennas 32-42 is coupled with one of the radios 44-48 such that communication signals transmitted from or received by each antenna is processed by an associated radio to facilitate wireless communications as desired. Each of the sectors has a plurality of antennas supported by an associated radio such that diversity communications are possible in each of the sectors when all of the radios are operating as desired.

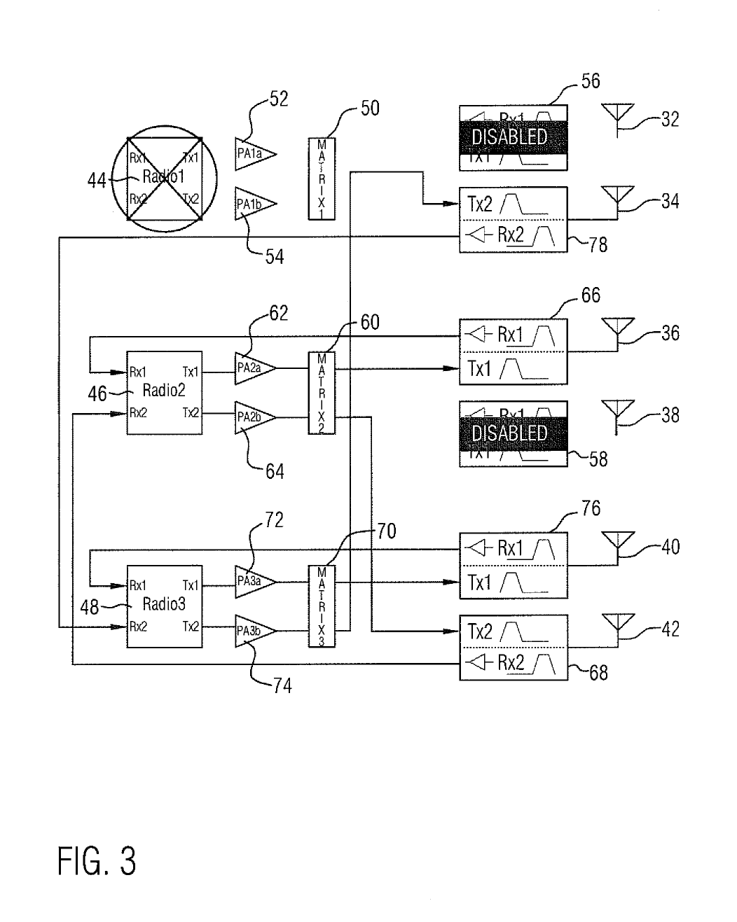

FIG. 3 schematically illustrates an example operating condition in which the first radio 44 has failed for some reason. The first radio 44 is coupled with the first sector antenna 32 and the second sector antenna 38 but the absence of connecting lines in FIG. 3 schematically shows the result of the first radio 44 failing. The filters 56 and 58 are disabled and the antennas 32 and 38 are not capable of providing wireless communication services within their respective sectors. Under the operating conditions shown in FIG. 3, some communications are still possible in the first sector 26 and the second sector 28 even though the first radio 44 has failed. The third radio 48 still supports communications over the first sector antenna 34. The second radio 46 still supports communications over the second sector antenna 36. In the scenario shown in FIG. 3, duplex communications are still possible in the third sector 30 because the third sector antennas 40 and 42 are coupled with fully operational radios. The first sector 26 and the second sector 28 are not completely blacked out but, instead, have the ability to provide at least simplex communication services using the first sector antenna 34 and the second sector antenna 36, for example.

As can be appreciated from FIG. 3, the unique arrangement of coupling the radios with the antennas in the different sectors allows for an improvement in wireless communication coverage even when an entire radio at a base station fails. In a conventional arrangement where the first radio 44 would have been the only radio associated with first sector antennas, the first radio 44 failing would have resulted in a complete loss of wireless communication coverage in the first sector 26. In the example of FIG. 3, on the other hand, wireless communication coverage can still continue in the first sector 26 even though the first radio 44 has completely failed.

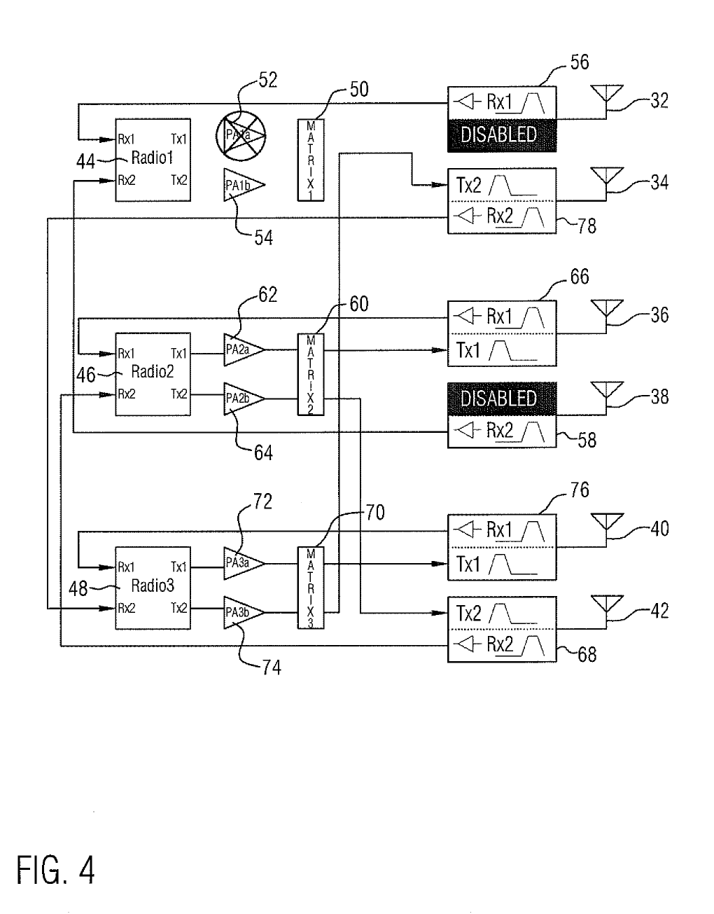

FIG. 4 shows another operating condition where the amplifier 52 associated with the first radio 44 has failed. In this example, the connection with the first sector antenna 32 is partially disabled and the connection with the second sector antenna 38 is partially disabled. Given that the power amplifier 52 is associated with the Butler matrix arrangement used for transmissions from the first radio 44, the transmission capabilities of the filters 56 and 58 are disabled as a result of the power amplifier 52 failing. Reception, however, is still possible on each of the first sector antenna 32 and the second sector antenna 38. As schematically shown in FIG. 4, the first radio 44 is still utilized for processing wireless communication signals received at each of the antennas coupled with that radio.

In the operating condition schematically shown in FIG. 4, duplex reception at the base station device 20 is possible within all of the sectors within the cell 24. Duplex transmission is possible from the base station device 20 within the third sector 30. Simplex transmission is available within the first sector 26 and the second sector 28.

The operating condition shown in FIG. 4 schematically illustrates how the unique coupling arrangement between the radios and the antennas provides improved wireless communication coverage compared to previous arrangements. Even though an entire power amplifier 52 has failed, the first radio 44 is still useful for processing signals received at antennas in more than one of the sectors served by the base station device 20. Additionally, at least simplex transmission communication capability still exists at the base station device 20 within all three sectors served by that base station.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A base station for wireless communications, comprising:
a plurality of antennas arranged such that there are at least two antennas configured for communications in each of a plurality of sectors; and
a plurality of radios;
at least two of the sectors having one of the at least two antennas coupled to one of the radios and another one of the at least two antennas coupled to a different one of the radios such that
diversity communications are possible in each of the at least two of the sectors if both of the one of the radios and the different one of the radios function, and
at least simplex communications are possible in each of the at least two of the sectors even if the one of the radios or the different one of the radios does not function

2. The base station of claim 1,
wherein the plurality of antennas comprises:
at least two first sector antennas configured for communications in a first sector;
at least two second sector antennas configured for communications in a second sector;
at least two third sector antennas configured for communications in a third sector;
and wherein the plurality of radios comprises:
a first radio coupled with one of the first sector antennas and coupled with one of the second sector antennas such that the first radio processes signals transmitted or received at the coupled antennas;
a second radio coupled with another one of the second sector antennas and coupled with one of the third sector antennas such that the second radio processes signals transmitted or received at the coupled antennas; and
a third radio coupled with another one of the first sector antennas and coupled with another one of the third sector antennas such that the third radio processes signals transmitted or received at the coupled antennas.

3. The base station of claim 2, wherein
diversity communications at the first sector antennas are possible when the first radio and the third radio both function;
diversity communications at the second sector antennas are possible when the second radio and the first radio both function; and
diversity communications at the third sector antennas are possible when the third radio and the second radio both function.

4. The base station of claim 3, wherein
simplex communications are possible in the first sector using the another one of the first sector antennas and the third radio if the first radio does not function; and
simplex communications are possible in the second sector using the another one of the second sector antennas and the second radio if the first radio does not function.

5. The base station of claim 3, wherein
simplex communications are possible in the second sector using the one of the second sector antennas and the first radio if the second radio does not function; and
simplex communications are possible in the third sector using the another one of the third sector antennas and the third radio if the second radio does not function.

6. The base station of claim 3, wherein
simplex communications are possible in the third sector using the one of the third sector antennas and the second radio if the third radio does not function; and
simplex communications are possible in the first sector using the one of the first sector antennas and the first radio if the third radio does not function.

7. The base station of claim 3, comprising
a first butler matrix having a plurality of first amplifiers associated with the first radio;
a second butler matrix having a plurality of second amplifiers associated with the second radio;
a third butler matrix having a plurality of third amplifiers associated with the third radio.

8. The base station of claim 7, wherein
diversity reception and simplex transmission is possible in the first and second sectors and diversity reception and diversity transmission is possible in the third sector if one of the first amplifiers does not function.

9. The base station of claim 7, wherein
diversity reception and simplex transmission is possible in the second and third sectors and diversity reception and diversity transmission is possible in the first sector if one of the second amplifiers does not function.

10. The base station of claim 7, wherein
diversity reception and simplex transmission is possible in the first and third sectors and diversity reception and diversity transmission is possible in the second sector if one of the third amplifiers does not function.

11. A method of conducting wireless communications at a base station including a plurality of antennas arranged such that there are at least two antennas configured for communications in each of a plurality of sectors and a plurality of radios, comprising the steps of:
coupling one of the at least two antennas in each of at least two of the sectors to one of the radios and another one of the at least two antennas in each of the at least two of the sectors to a different one of the radios;
conducting diversity communications over the at least two antennas in each of the at least two of the sectors if both of the one of the radios and the different one of the radios function, and
conducting at least simplex communications over one of the at least two antennas in each of the at least two of the sectors even if the one of the radios or the different one of the radios does not function.

12. The method of claim 11, wherein the plurality of antennas are configured to serve first, second and third sectors and the plurality of radios comprises a first radio, a second radio and a third radio, the method comprising:
processing signals transmitted from or received at one of the antennas serving the first sector using the first radio;
processing signals transmitted from or received at one of the antennas serving the second sector using the first radio;
processing signals transmitted from or received at another one of the antennas serving the second sector using the second radio;
processing signals transmitted from or received at one of the antennas serving the third sector using the second radio;
processing signals transmitted from or received at another one of the antennas serving the third sector using the third radio; and
processing signals transmitted from or received at another one of the antennas serving the first sector using the third radio.

13. The method of claim 12, comprising
conducting at least some communications in each of the first, second and third sectors even if one of the radios does not function.

14. The method of claim 12, comprising
conducting diversity communications using the antennas serving the first sector antennas when the first radio and the third radio both function;
conducting diversity communications using the antennas serving the second sector when the second radio and the first radio both function; and
conducting diversity communications using the antennas serving the third sector when the third radio and the second radio both function.

15. The method of claim 12, comprising
conducting simplex communications in the first sector using the another one of the antennas serving the first sector and the third radio if the first radio does not function; and
conducting simplex communications in the second sector using the another one of the antennas serving the second sector and the second radio if the first radio does not function.

16. The method of claim 12, comprising
conducting simplex communications in the second sector using the one of the antennas serving the second sector and the first radio if the second radio does not function; and
conducting simplex communications in the third sector using the another one of the antennas serving the third sector and the third radio if the second radio does not function.

17. The method of claim 12, comprising
conducting simplex communications in the third sector using the one of the antennas serving the third sector and the second radio if the third radio does not function; and
conducting simplex communications in the first sector using the one of the antennas serving the first sector and the first radio if the third radio does not function.

18. The method of claim 12, wherein the base station includes a butler matrix and a plurality of amplifiers associated with each radio, the method comprising
conducting diversity reception and simplex transmission in the first and second sectors and diversity reception and diversity transmission in the third sector if one of the amplifiers associated with the first radio does not function.

19. The method of claim 12, wherein the base station includes a butler matrix and a plurality of amplifiers associated with each radio, the method comprising
conducting diversity reception and simplex transmission in the second and third sectors and diversity reception and diversity transmission in the first sector if one of the amplifiers associated with the second radio does not function.

20. The method of claim 12, wherein the base station includes a butler matrix and a plurality of amplifiers associated with each radio, the method comprising
conducting diversity reception and simplex transmission in the first and third sectors and diversity reception and diversity transmission in the second sector if one of the amplifiers associated with the third radio does not function.
